(19) United States
(12) Patent Application Publication
(10) Pub. No.: US 2010/0298522 A1
(43) Pub. Date: Nov. 25, 2010

(54) PROCESS FOR PRODUCING CARBON MATERIAL

(76) Inventors: Junji Suzuki, Osaka (JP); Taketoshi Kikuchi, Osaka (JP)

Correspondence Address: BIRCH STEWART KOLASCH & BIRCH, PO BOX 747, FALLS CHURCH, VA, 22040-0747, US

(21) Appl. No.: 12/863,653

(22) PCT Filed: Feb. 4, 2009
(86) PCT No.: PCT/JP2009/052250

§ 371 Date: Jul. 20, 2010

(30) Foreign Application Priority Data
Feb. 12, 2008 (JP) 2008-030010
Jul. 25, 2008 (JP) 2008-191892
Oct. 31, 2008 (JP) 2008-280994
Nov. 7, 2008 (JP) 2008-286279

(51) Int. Cl. C08G 16/00

(52) U.S. Cl. 528/230

(57) ABSTRACT

A process for producing a carbon material comprising the following steps (A) and (B): Step (A): a step of reacting a compound represented by the formula (1): wherein R represents a hydrogen atom etc., R′ represents a hydrogen atom etc., and n represents 3, 5 or 7, with an aldehyde compound to obtain a polymer, Step (B): a step of heating the polymer obtained in Step (A) at 600 to 3000° C. under an inert gas atmosphere.

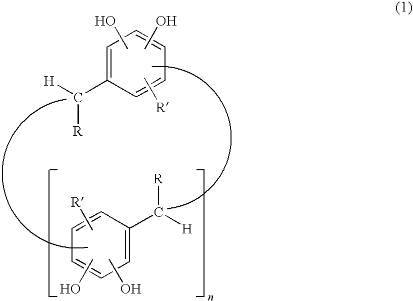

### FIELD OF THE INVENTION

The present invention relates to a process for producing a carbon material.

### BACKGROUND OF THE INVENTION

A carbon material such as a carbon powder is used for materials for electrodes such as lithium ion secondary cells.

JP 10-188978 A discloses a process for producing a carbon material comprising curing a resin, which is obtained by reacting o-cresol with formaldehyde, with a use of hexamethylenetetramine to obtain a cured resin followed by heating the cured resin at 1000° C. under an argon gas atmosphere. Further, JP 10-188978 A also discloses the lithium ion secondary cell comprising the obtained carbon materials has 341 mAh/g of an initial charge and discharge capacity.

### DISCLOSURE OF THE INVENTION

The present invention provides the followings:

[1] A process for producing a carbon material comprising the following steps (A) and (B):

Step (A): a step of reacting a compound represented by the formula (1):

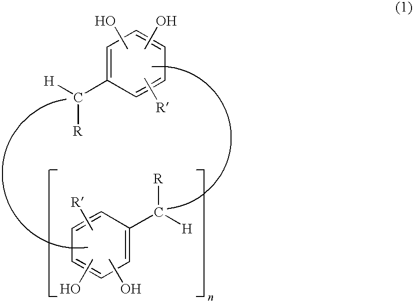

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer,

Step (B): a step of heating the polymer obtained in Step (A) at 600 to 3000° C. under an inert gas atmosphere;

[2] A process for producing a carbon material comprising the following steps (A), (C) and (D):

Step (A): a step of reacting a compound represented by the formula (1):

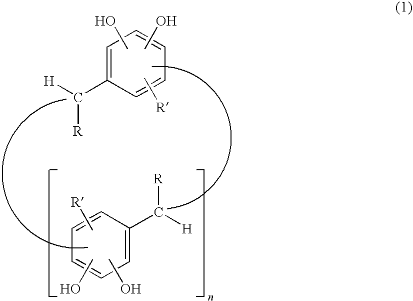

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer,

Step (C): a step of heating the polymer obtained in Step (A) at 400° C. or less under an oxidizing gas atmosphere to obtain a calcined product,

Step (D): a step of heating the calcined product obtained in Step (C) at 600 to 3000° C. under an inert gas atmosphere; [3] The process for producing a carbon material according to

[1] or [2], wherein the reaction temperature is 0 to 100° C. and the reaction time is 10 minutes to 10 days in Step (A);

[4] The process for producing a carbon material according to any on of [1] to [3], wherein the reaction is conducted in the presence of a basic catalyst in Step (A);
[5] The process for producing a carbon material according to any one of [1] to [4], wherein Step (A) further comprises a step of washing the obtained polymer;
[6] The process for producing a carbon material according to any one of [1] to [5], wherein Step (A) further comprises a step of drying the obtained polymer;
[7] The process for producing a carbon material according to any one of [1] to [6], wherein R′ is a hydrogen atom;
[8] The process for producing a carbon material according to any one of [1] to [7], wherein R is a C1-C12 alkyl group;
[9] The process for producing a carbon material according to any one of [1] to [8], wherein the aldehyde compound is formaldehyde;
[10] An electrode comprising a carbon material obtained according to any one of [1] to [9];
[11] A lithium ion secondary cell comprising an electrode according to [10];
[12] A lithium ion capacitor comprising an electrode according to [10];
[13] A carbon material obtainable by reacting a compound represented by the formula (1):

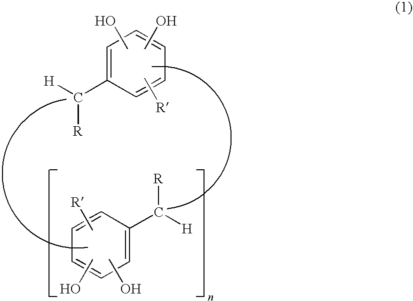

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer, and heating the obtained polymer at 600 to 3000° C. under an inert gas atmosphere;
[14] A carbon material obtainable by reacting a compound represented by the formula (1):

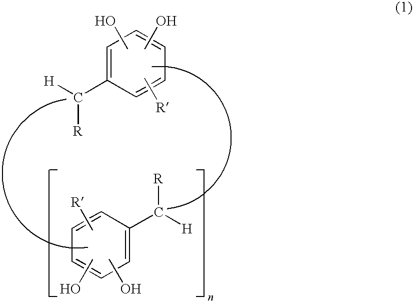

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer,

heating the obtained polymer at. 400° C. or less under an oxidizing gas atmosphere to obtain a calcined product, and

heating the calcined product obtained in the above at 600 to 3000° C. under an inert gas atmosphere;

[15] The carbon material according to [13] or [14], wherein a ratio of number of hydrogen atoms to number of carbon atoms (H/C) of the carbon material is 0.08 to 0.25;
[16] The carbon material according to [13], [14] or [15], wherein a specific surface area is 0 to 1,000 m²/g.

### BRIEF DESCRIPTION OF THE DRAWINGS

FIG. 1 is an exploded diagram of one embodiment of a cell used in Examples of the invention.

FIG. 2 is an exploded diagram of one embodiment of a cell used in Examples of the invention.

Each of numerals referred in the drawings denotes the corresponding terms respectively as listed below.
1: Nut
2: Washer
3: Bolt hole
4: Fixing metallic plate
5: Blade spring
6: Metallic plate
7: Cathode (lithium foil)
8: Separator
9: Hole
10: Chassis
11: Electrode
12: Metallic plate
13: Insulating plate
14: Fixing metallic plate
15: Bolt

### MODES FOR CARRYING OUT THE INVENTION

First, a compound represented by the formula (1):

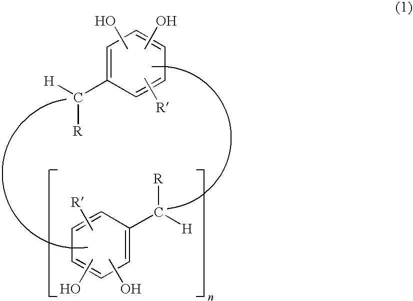

(hereinafter, simply referred to as the compound (1)) will be illustrated.

In the formula (1), R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom.

Examples of the C1-C12 hydrocarbon group include a C1-C12 linear or branched chain alkyl group such as a methyl group, an ethyl group, a propyl group, an isopropyl group, a butyl group, an isobutyl group, a tert-butyl group, a pentyl group, a hexyl group, an octyl group, a 2-ethylhexyl group, a decyl group and a dodecyl group; a C3-C12 cycloalkyl group such as a cyclopentyl group and a cyclohexyl group; a C6-C12 aromatic hydrocarbon group such as a phenyl group, a 2-methylphenyl group, a 3-methylphenyl group, a 4-methylphenyl group, a 1-naphthyl group and a 2-naphthyl group; and a C7-C12 aralkyl group such as a benzyl group and a 2-phenylethyl group. The C1-C12 alkyl group is preferable, and a C2-C6 alkyl group is more preferable.

Examples of the C1-C6 alkoxy group include a methoxy group, an ethoxy group, a propoxy group, an isopropoxy group, a butoxy group, an isobutoxy group, a tert-butoxy group, a pentyloxy group and a hexyloxy group.

Examples of the C6-C20 aryloxy group include a phenoxy group, a 2-methylphenoxy group, a 3-methylphenoxy group, a 4-methylphenoxy group and a naphthoxy group.

Examples of the C1-C6 alkylthio group include a methylthio group, an ethylthio group, a propylthio group, an isopropylthio group, a butylthio group, an isobutylthio group, a tert-butylthio group, a pentylthio group and a hexylthio group.

Examples of the C2-C20 acylamino group include an acetylamino group, a propionylamino group and a benzoylamino group.

Examples of the halogen atom include a fluorine atom, a chlorine atom, a bromine atom and an iodine atom.

Examples of the C1-C12 hydrocarbon group substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom include a 2-hydroxyphenyl group, a 3-hydroxyphenyl group, a 4-hydroxyphenyl group, a 2-methoxyphenyl group, a 3-methoxyphenyl group, a 4-methoxyphenyl group, a 2-chlorophenyl group, a 3-chlorophenyl group, a 4-chlorophenyl group, a 2-bromophenyl group, a 3-bromphenyl group, a 4-bromophenyl group, a 2-fluorophenyl group, a 3-fluorophenyl group, a 4-fluorophenyl group, a 2-methylthiophenyl group, a 3-methylthiophenyl group, a 4-methylthiophenyl group, a 2-carboxyphenyl group, a 3-carboxyphenyl group, a 4-carboxyphenyl group, a 3-nitrophenyl group, a 4-aminophenyl group, a 4-cyanophenyl group and a 4-acetylaminophenyl group.

R is preferably a C1-C12 alkyl group, and more preferably a C2-C6 alkyl group.

R′ represents a hydrogen atom or a methyl group, and preferably represents a hydrogen atom.

In the formula (1), n represents 3, 5 or 7, and preferably represents 3.

Two hydroxyl groups bonding to a benzene ring of the formula (1) are usually bonded to an ortho-position and a para-position of —CH(R)—.

The compound (1) has multiple stereoisomers, and any one of stereoisomers may be used, and a mixture of stereoisomers may be used.

Examples of the compound (1) include

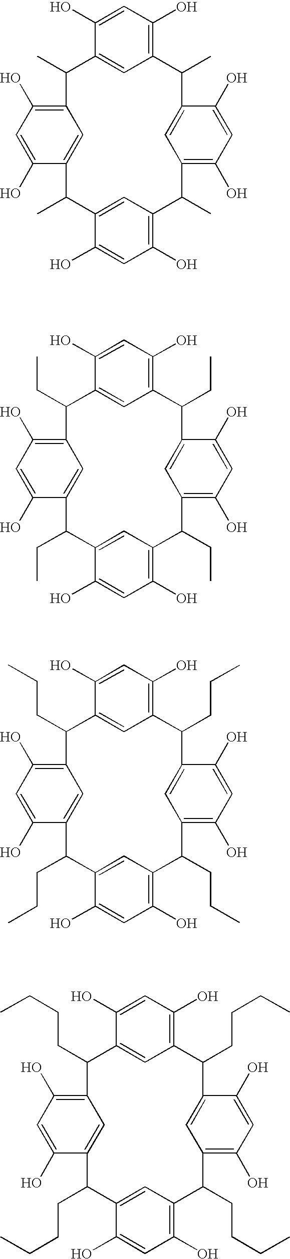

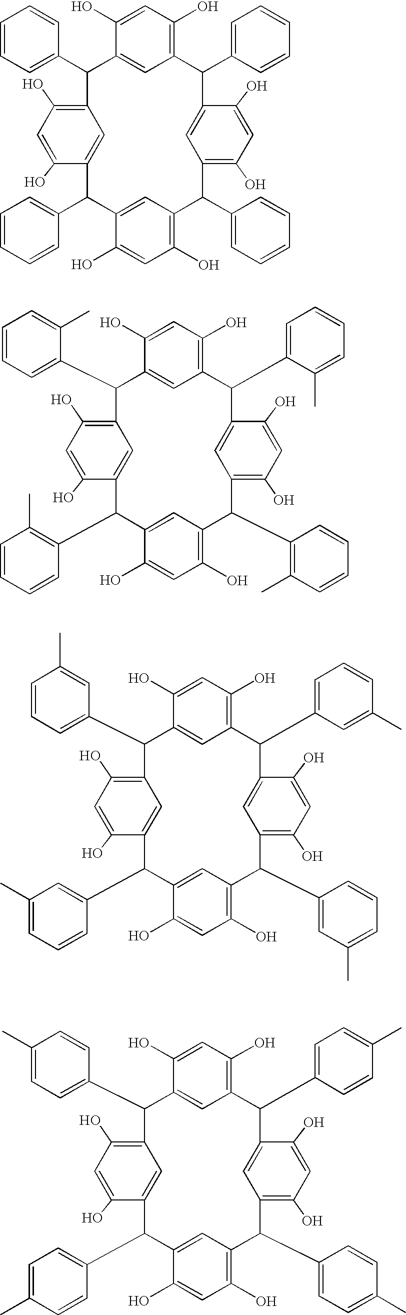

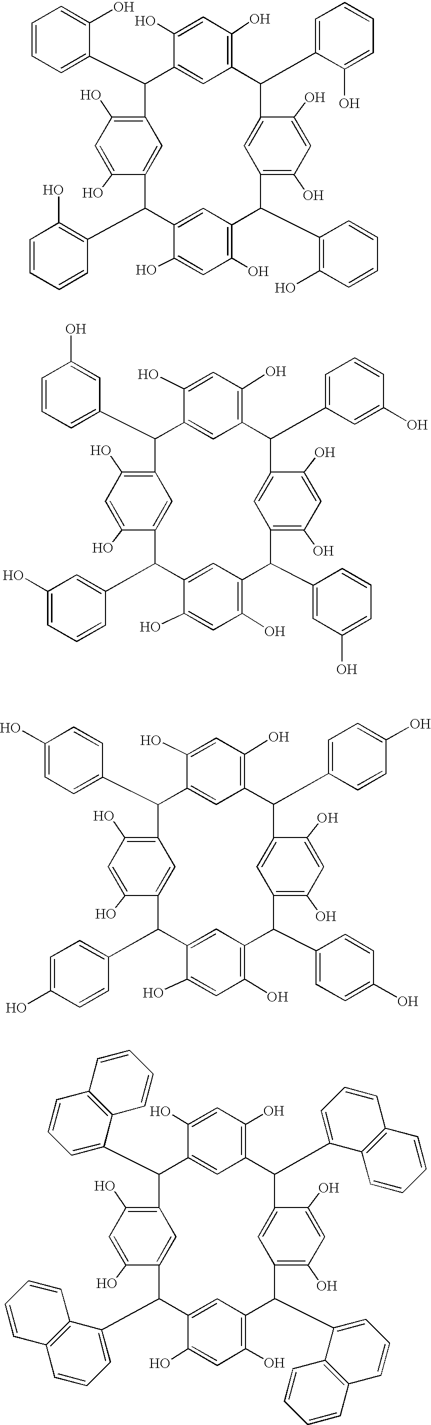

The compound (1) can be produced by reacting a compound represented by the formula (2):

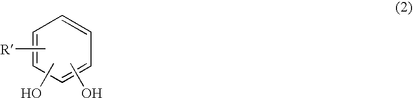

wherein R′ is the same as defined above (hereinafter, simply referred to as the compound (2)), with an aldehyde compound represented by the formula (3):

R—CHO (3)

wherein R is the same as defined above (hereinafter, simply referred to as the aldehyde compound (3)), in the presence of an acid catalyst (e.g. Tetrahedron, 52, 2663-2704 (1996)).

Examples of the compound (2) include resorcinol, 2-methylresorcinol and 5-methylresorcinol, and resorcinol is preferable. A commercially available compound (2) is usually used.

Examples of the aldehyde compound (3) include an aliphatic aldehyde compound such as formaldehyde, paraformaldehyde, trioxane, acetaldehyde, propionaldehyde, butyraldehyde, isobutyraldehyde, hexylaldehyde, dodecylaldehyde, 3-phenylpropionaldehyde and 5-hydroxypentylaldehyde; and an aromatic aldehyde compound such as benzaldehyde, 1-naphthaldehyde, o-methylbenzaldehyde, m-methylbenzaldehyde, p-methylbenzaldehyde, o-hydroxybenzaldehyde, m-hydroxybenzaldehyde, p-hydroxybenzaldehyde, p-tert-butylbenzaldehyde, p-phenylbenzaldehyde, o-methyoxybenzaldehyde, m-methoxybenzaldehyde, p-methoxybenzaldehyde, o-chlorobenzaldehyde, m-chlorobenzaldehyde, p-chlorobenzaldehyde, o-bromobenzaldehyde, m-bromobenzaldehyde, p-bromobenzaldehyde, o-fluorobenzaldehyde, m-fluorobenzaldehyde, p-fluorobenzaldehyde, o-methylthiobenzaldehyde, m-methylthiobenzaldehyde, p-methylthiobenzaldehyde, o-carboxybenzaldehyde, m-carboxybenzaldehyde, p-carboxybenzaldehyde, m-nitrobenzaldehyde, p-aminobenzaldehyde, p-acetylaminobenzaldehyde and p-cyanobenzaldehyde.

The aliphatic aldehyde compound is preferable and a C2-C12 aliphatic aldehyde is more preferable, and acetaldehyde, propionaldehyde, butyraldehyde and isobutyraldehyde are especially preferable. A commercially available aldehyde compound (3) is usually used.

An aqueous solution of the aldehyde compound (3) such as formalin may be used.

The used amount of the aldehyde compound (3) is usually 1 to 3 moles and preferably 1.2 to 2.5 moles per 1 mole of the compound (2).

Examples of the acid catalyst include mineral acids such as hydrochloric acid, sulfuric acid, phosphoric acid and nitric acid; organic sulfonic acids such as p-toluenesulfonic acid; and organic carboxylic acids such as acetic acid, and mineral acids are preferable, and hydrochloric acid and sulfuric acid are more preferable.

The used amount of the acid catalyst is usually 0.001 to 3 moles per 1 mole of the compound (2).

The reaction of the compound (2) and the aldehyde compound (3) is usually conducted in a solvent.

Examples of the solvent include water and a hydrophilic solvent, and examples of the hydrophilic solvent include a hydrophilic alcohol solvent such as methanol, ethanol and isopropanol, a hydrophilic ether solvent such as tetrahydrofuran and a hydrophilic amide solvent such as N,N-dimethylformamide and N-methyl-2-pyrrolidone. Two or more kinds of the solvent may be mixed to use. A C1-C3 alcohol solvent and a mixture of the C1-C3 alcohol solvent and water are preferable, and the C1-C3 alcohol solvent is more preferable.

Herein, “hydrophilic solvent” means a solvent capable of being miscible in any proportion with water.

The used amount of the solvent is usually 0.2 to 100 parts by weight and preferably 0.5 to 10 parts by weight per 1 part by weight of the compound (2).

The reaction of the compound (2) and the aldehyde compound (3) is usually carried out by mixing the compound (2), the aldehyde compound (3), the acid catalyst and the solvent, and the mixing order thereof is not limited. The reaction may be conducted by mixing compound (2), the aldehyde compound (3), the acid catalyst and the solvent, and the reaction may be conducted by adding the aldehyde compound (3) to a mixture of the compound (2), the acid catalyst and the solvent. Alternatively, the compound (2) may be added to a mixture of the aldehyde compound (3), the acid catalyst and the solvent to conduct the reaction, and the acid catalyst may be added to a mixture of the compound (2), the aldehyde compound (3) and the solvent to conduct the reaction.

The reaction temperature is usually 0 to 100° C. and preferably at 30 to 90° C., and the reaction time is usually 10 minutes to 24 hours.

The obtained compound (1) may be dried at about 10° C. to about 100° C. by ventilation or under reduced pressure. The obtained compound (1) may be dried after washing with a hydrophilic organic solvent. Examples of the hydrophilic organic solvent include an alcohol solvent such as methanol, ethanol, propanol and tert-butanol; an aliphatic nitrile solvent such as acetonitrile; an aliphatic ketone solvent such as acetone; an aliphatic sulfoxide solvent such as dimethyl sulfoxide; and an aliphatic carboxylic acid solvent such as acetic acid.

The dried compound (1) may be used for the following Step (A) and the reaction mixture obtained may be used for the following step (A).

The process for producing a carbon material of the present invention comprises the following steps (A) and (B):

Step (A): a step of reacting the compound (1) with an aldehyde compound to obtain a polymer, and

Step (B): a step of heating the polymer obtained in Step (A) at 600 to 3000° C. under an inert gas atmosphere.

The Step (A) will be illustrated below.

The reaction of the compound (1) and an aldehyde compound is usually conducted in the presence of a basic catalyst.

Examples of the aldehyde compound include the same as described above. Formaldehyde is preferable, and paraformaldehyde or trioxane may be used as formaldehyde. An aqueous solution of the aldehyde compound such as formalin may be used.

The used amount of the aldehyde compound is usually 0.1 to 6 moles and preferably 1 to 5 moles per 1 mole of the compound (1).

Examples of the basic catalyst include ammonia; an alkali metal carbonate such as lithium carbonate, sodium carbonate and potassium carbonate; an alkali metal hydroxide such as lithium hydroxide, sodium hydroxide and potassium hydroxide; and an alkali earth metal carbonate such as barium carbonate. The alkali metal carbonate and ammonia are preferable, and sodium carbonate and ammonia are more preferable, and ammonia is especially preferable.

The used amount of the basic catalyst is usually 0.001 to 1000 equivalents, preferably 0.005 to 10 equivalents and more preferably 0.01 to 5 equivalents. Herein, “equivalent” means (molar of the compound (1))/[(molar of the basic catalyst)/(a valence of the basic catalyst)]. When the reaction mixture containing the compound (1) and the acid catalyst is used, the basic catalyst of which amount is enough to neutralize the acid catalyst contained in the reaction mixture is further used.

The reaction of the compound (1) and the aldehyde compound is usually conducted in a solvent.

Examples of the solvent include water and a hydrophilic solvent, and examples of the hydrophilic solvent include the same as described above. Two or more kinds of the solvent may be mixed to use. A C1-C3 alcohol solvent, water and a mixture of the C1-C3 alcohol solvent and water are preferable.

The used amount of the solvent is usually 0.001 to 5 parts by weight and preferably 0.01 to 1 parts by weight per 1 part by weight of the compound (1).

The reaction of the compound (1) and the aldehyde compound is usually carried out by mixing the compound (1), the aldehyde compound, the basic catalyst and the solvent, and the mixing order is not limited. The compound (1), the aldehyde compound, the basic catalyst and the solvent may be mixed to conduct the reaction at 0 to 100° C. and preferably at 30 to 90° C., and the aldehyde compound may be added to a mixture of the compound (1), the basic catalyst and the solvent to conduct the reaction at 0 to 100° C. and preferably at 30 to 90° C. Alternatively, the compound (1) may be added to a mixture of the aldehyde compound, the basic catalyst and the solvent to conduct the reaction at 0 to 100° C. and preferably at 30 to 90° C., and the basic catalyst may be added to a mixture of the compound (1), the aldehyde compound and the solvent to conduct the reaction at 0 to 100° C. and preferably at 30 to 90° C. The aldehyde compound is preferably added to a mixture of the compound (1), the basic catalyst and the solvent to conduct the reaction at 0 to 100° C. and preferably at 30 to 90° C.

The reaction time is usually 10 minutes to 10 days. After completion of the reaction, the reaction mixture containing a polymer is usually washed with a solvent for washing, and then the polymer is usually separated from the reaction mixture by filtration, decantation or the like.

Examples of the solvent for washing include an aqueous solution or an alcohol solution of an acid such as hydrochloride, sulfuric acid and acetic acid. Examples of the alcohol of the above-mentioned alcohol solution include methanol, ethanol, propanol, isopropanol and tert-butanol.

The washing is usually conducted at a temperature below the boiling point of the solvent for washing.

Although the separated polymer may be used as it is for heating described below, the polymer is preferably dried to use for heating described below.

The drying may be carried out by ventilation or under reduced pressure. The drying temperature is usually room temperature to 100° C.

When the above-mentioned reaction of the compound (1) and the aldehyde compound is conducted in water, the drying is preferably conducted after washing the polymer with a water-soluble solvent. When the above-mentioned washing is conducted using an aqueous solution of an acid, the drying is preferably conducted after washing the polymer with a water-soluble solvent. Examples of the water-soluble solvent include an alcohol solvent such as methanol, ethanol, n-propanol, isopropanol and tert-butanol, an aliphatic nitrile solvent such as acetonitrile, an aliphatic ketone solvent such as acetone, an aliphatic sulfoxide solvent such as dimethyl sulfoxide, and an aliphatic carboxylic acid solvent such as acetic acid. The alcohol solvent, the aliphatic sulfoxide solvent and the aliphatic carboxylic acid solvent are preferable, and tert-butanol, dimethyl sulfoxide and acetic acid are more preferable.

Alternatively, the separated polymer may be freeze-dried. The temperature of freeze-drying is usually −70 to 20° C. and preferably −30 to 10° C. The freeze-drying is usually conducted under vacuum.

Alternatively, the separated polymer may be dried under supercritical state using CO₂ or the like as described in JP 09-328308 A.

Next, the Step (B) will be illustrated.

In the Step (B), the polymer obtained in Step (A) is heated at 600 to 3000° C. under an inert gas atmosphere to obtain a carbon material. The polymer obtained in Step (A) is preferably heated at 800 to 1000° C. and more preferably heated at 850 to 990° C.

Examples of the inert gas include a nitrogen and a rare gas such as a helium, a neon, an argon, a krypton and a xenon.

The heating is preferably conducted in a calcining furnace such as a rotary kiln, a roller hearth kiln, a pusher kiln, a multiple-hearth furnace, a fluidized bed furnace, a high-temperature calcining furnace. The rotary kiln is more preferably used in viewpoint that much amount of the polymer can easily be heated.

The heating time is usually 1 minute to 24 hours.

The heating is usually conducted by placing the obtained polymer in a calcining furnace, putting an inert gas into the calcining furnace and then heating at 600 to 3000° C. for a given time. The heating may be conducted with flowing an inert gas through the calcining furnace.

Alternatively, a carbon material can also be produced by conducting the following Steps (C) and (D) after the Step (A):

Step (C): a step of heating the polymer obtained in Step (A) at 400° C. or less under an oxidizing gas atmosphere to obtain a calcined product, and

Step (D): a step of heating the calcined product obtained in Step (C) at 600 to 3000° C. under an inert gas atmosphere.

In Step (C), the polymer obtained in Step (A) is preferably heated at 150 to 300° C.

The heating time at 400° C. or less is usually 1 minute to 24 hours.

Examples of an oxidizing gas include H₂O, CO₂, O₂ and air. The oxidizing gas may be diluted with the above-mentioned inert gas.

The heating is preferably conducted in a calcining furnace and examples of the calcining furnace include the same as described above. The rotary kiln is more preferably used in viewpoint that much amount of the polymer can easily be heated.

The heating is usually conducted by placing the obtained polymer in a calcining furnace, putting an oxidizing gas into the calcining furnace, heating at 400° C. or less for a given time.

When the heating is conducted at 190 to 400° C., the oxidizing gas may be diluted with the inert gas, and the concentration of the oxidizing gas in the diluted oxidizing gas is preferably 15% by volume or less.

In the Step (D), the calcined product obtained in Step (C) is heated at 600 to 3000° C. under an inert gas atmosphere to obtain a carbon material. The calcined product obtained in Step (C) is preferably heated at 800 to 1000° C. and more preferably heated at 850 to 990° C.

Examples of the inert gas include the same as described above.

The heating at 600 to 3000° C. under an inert gas atmosphere is preferably conducted in a calcining furnace such as a rotary kiln, a roller hearth kiln, a pusher kiln, a multiple-hearth furnace, a fluidized bed furnace, a high-temperature calcining furnace. The rotary kiln is more preferably used in viewpoint that much amount of the calcined product can easily be heated.

The heating time is usually 1 minute to 24 hours.

The heating is usually conducted by placing the obtained calcined product in a calcining furnace, putting an inert gas into the calcining furnace and then heating at 600 to 1000° C. for a given time. The heating may be conducted with flowing an inert gas through the calcining furnace.

The carbon material thus obtained can be used for materials for electrodes in dry batteries, sensor for a piezoelectric devices, electric double-layer capacitors, lithium ion capacitors, lithium ion secondary cells, sodium ion secondary cells, carriers for supporting catalysts, carriers for chromatography, adsorbents and the like. Especially, the carbon material of the present invention is preferably used for materials for electrodes capable of discharging and charging lithium ions such as lithium ion capacitors and lithium ion secondary cells.

A ratio of number of hydrogen atoms to number of carbon atoms (H/C) of the carbon material thus obtained is usually 0.08 to 0.25, preferably 0.10 to 0.25 and more preferably 0.12 to 0.25.

A carbon content of the carbon material thus obtained, which is measured by elemental analysis, is usually 80% or more.

A specific surface area of the carbon material thus obtained is usually 0 to 1,000 m²/g, preferably 1 to 1,000 m²/g, more preferably 1 to 600 m²/g, and especially preferably 100 to 600 m²/g.

The carbon material thus obtained is usually ground to a powdery carbon materials having Median particle diameter based on volume of 1 to 50 μm, preferably 1 to 10 μm, more preferably 4 to 7 μm and especially preferably 5 to 6 μm.

Examples of the suitable grinding methods include methods of grinding using a grinding machine for fine grinding such as an impact wear grinder, a centrifugal grinder, a ball mill (e.g. a tube mill, a compound mill, a conical ball mill, a rod mill and a planetary boll mill), a vibration mill, a colloid mill, a friction disk mill and a jet mill, and the ball mill is usually used as the grinding machine. When the ball mill is used, balls and grinding vessels made of non-metals such as alumina and agate is preferable in viewpoint of avoiding incorporation of metal powders in the carbon fine particles obtained.

The electrode of the present invention comprises a carbon material of the present invention, and is preferably used for anodes of lithium ion secondary cell and of lithium ion capacitors.

A binder is usually used as raw materials so as to provide easy molding as an electrode.

The electrode is usually produced by a method comprising molding a mixture of a carbon material, a binder and the like on a current collector.

The electrode can be produced by coating a slurry obtained by mixing the present carbon material, a binder, a solvent and the like on a current collector by doctor blade method or dipping the collector in the above-mentioned slurry, followed by drying. The electrode can also be produced by preparing a sheet by mixing the present carbon material, a binder, a solvent and the like, molding the obtained mixture and then drying, disposing the sheet on a current collector with interposing a conductive adhesive and then subjecting to pressing and heating treatments and drying. The electrode can also be produced by molding a mixture of the present carbon material, a binder, a liquid lubricant and the like on a current collector, removing the liquid lubricant to obtain a sheet and then stretching the sheet in mono- or multi-axial directions.

When the electrode is formed in a sheet shape, the thickness thereof is about 5 to about 1,000 μm.

Examples of ingredient materials for the current collector include metals such as nickel, aluminum, titanium, copper, gold, silver, platinum, aluminum alloy and stainless steel; carbon material or activated carbon fibers coated with nickel, aluminum, zinc, copper, tin or lead or an alloy thereof by plasma or ark spraying; and conductive films composed of resins containing a conducting agent dispersed therein such as rubbers and styrene-ethylene-butylene-styrene copolymer (SEBS).

Examples of configurations of the current collector include foil, plate, mesh, net, lath, punching and emboss and a combination thereof (for example, meshed plate).

Corrugated surface may be formed on a surface of the current collector by etching.

Examples of the binder include polymers of fluorine compounds. Examples of the fluorine compounds include a fluorinated C1-C18 alkyl acrylate; a fluorinated C1-C18 alkyl methacrylate; a perfluoroalkyl acrylate such as perfluorododecyl acrylate, perfluorooctyl acrylate and perfluorobutyl acrylate; a perfluoroalkyl methacrylate such as perfluorododecyl methacrylate, perfluorooctyl methacrylate and perfluorobutyl methacrylate; a perfluoroalkyl-substituted alkyl acrylate such as perfluorohexylethyl acrylate and perfluorooctylethyl acrylate; a perfluoroalkyl-substituted alkyl methacrylate such as perfluorohexylethyl methacrylate and perfluorooctylethyl methacrylate; a perfluoroalkyloxyalkyl acrylate such as perfluorododecyloxyethyl acrylate and perfluorodecyloxyethyl acrylate; a perfluoroalkyloxyalkyl methacrylate such as perfluorododecyloxyethyl methacrylate and perfluorodecyloxyethyl methacrylate; a fluorinated C1-C18 alkyl crotonate; a fluorinated C1-C18 alkyl maleate; a fluorinated C1-C18 alkyl fumarate; a fluorinated C1-C18 alkyl itaconate; a C2-C10 olefin substituted with a fluorinated alkyl group having 1 to 17 fluorine atoms such as perfluorohexylethylene; a C2-C10 olefin having 1 to 20 fluorine atoms in which the fluorine atom binds to the double-bonded carbon atom such as tetrafluoroethylene, trifluoroethylene, vinylidene fluoride and hexafluoropropylene.

Examples of the binder include polymers produced by addition polymerization of monomers having an ethylenic double bond but not having a fluorine atom.

Examples of the monomers include C1-C22 alkyl acrylates such as methyl acrylate, ethyl acrylate, butyl acrylate, isobutyl acrylate, 2-ethylhexyl acrylate, isodecyl acrylate, lauryl acrylate and octadecyl acrylate; C1-C22 alkyl methacrylates such as methyl methacrylate, ethyl methacrylate, butyl methacrylate, isobutyl methacrylate, 2-ethylhexyl methacrylate, isodecyl methacrylate, lauryl methacrylate and octadecyl methacrylate; C3-C22 cycloalkyl acrylates such as cyclohexyl acrylate; C3-C22 cycloalkyl methacrylates such as cyclohexyl methacrylate; acrylates having an aromatic ring such as benzyl acrylate and phenylethyl acrylate; methacrylates having an aromatic ring such as benzyl methacrylate and phenylethyl methacrylate; alkyleneglycol or dialkyleneglycol monoester of acrylic acids wherein the alkylene group has 2 to 4 carbon atoms such as 2-hydroxyethyl acrylate, 2-hydroxypropyl acrylate and diethylene glycol monoester of acrylic acid; alkyleneglycol or dialkyleneglycol monoester of methacrylic acids wherein the alkylene group has 2 to 4 carbon atoms such as 2-hydroxyethyl methacrylate, 2-hydroxypropyl methacrylate and diethylene glycol monoester of methacrylic acid; (poly)glycerin monoester of acrylic acid wherein the (poly)glycerin has a polymerization degree of 1 to 4; (poly)glycerin monoester of methacrylic acid wherein the (poly)glycerin has a polymerization degree of 1 to 4; (poly)ethyleneglycol diester of acrylic acid wherein the (poly)ethyleneglycol has a polymerization degree of 1 to 100; (poly)ethyleneglycol diester of methacrylic acid wherein the (poly)ethyleneglycol has a polymerization degree of 1 to 100; (poly)propyleneglycol diester of acrylic acid wherein the (poly)propyleneglycol has a polymerization degree of 1 to 100; (poly)propyleneglycol diester of methacrylic acid wherein the (poly)propyleneglycol has a polymerization degree of 1 to 100; 2,2-bis(4-hydroxyethylphenyl)propyl diacrylate; 2,2-bis(4-hydroxyethylphenyl)propyl dimethacrylate; trimethylolpropane triacrylate; trimethylolpropane trimethacrylate; acrylamide-based monomers such as acrylamide, N-methylol acrylamide and diacetone acrylamide; methacrylamide-based monomers such as methacrylamide and N-methylol methacrylamide; monomers containing a cyano group such as acrylonitrile, 2-cyanoethyl acrylate, 2-cyanoethyl acrylamide, methacrylonitrile and 2-cyanoethyl methacrylate; styrene-based monomers such as styrene, α-methylstyrene, vinyltoluene, p-hydroxystyrene and divinylbenzene; diene monomers such as C4-C12 alkadiene such as butadiene, isoprene and chloroprene; alkenyl carboxylate monomers such as vinyl ester of C2-C12 carboxylic acid such as vinyl acetate, vinyl propionate, vinyl butyrate and vinyl octanoate, allyl ester of C2-C12 carboxylic acid such as allyl acetate, allyl propionate and allyl octanoate, and methallyl ester of C2-C12 carboxylic acid such as methallyl acetate, methallyl propionate and methallyl octanoate; monomers having an epoxy group such as glycidyl acrylate, allyl glycidyl ether, glycidyl methacrylate and methallyl glycidyl ether; C2-C12 monoolefines such as ethylene, propylene, 1-butene, 1-octene and 1-dodecene; monomers containing chlorine, bromine or iodine atoms such as vinyl chloride and vinylidene chloride; acrylic acid; methacrylic acid; and monomers having conjugated double bonds such as butadiene and isoprene.

Further, the polymers produced by addition polymerization may be copolymers composed of a plurality of monomers such as ethylene-vinyl acetate copolymer, styrene-butadiene copolymer and ethylene-propylene copolymer. Furthermore, polymers of vinyl carboxylate may be partially or completely saponified such as polyvinyl alcohol.

The binder may be copolymers composed of fluorine compounds and monomers having an ethylenic double bond but not having a fluorine atom.

Examples of the binder also include polysaccharides such as starch, methyl cellulose, carboxymethyl cellulose, hydroxymethyl cellulose, hydroxyethyl cellulose, hydroxypropyl cellulose, carboxymethyl hydroxyethyl cellulose and nitrocellulose; phenol resins; melamine resins; polyurethane resins; urea resins; polyimide resins; polyamide-imide resins; petroleum pitches and coal-tar pitches.

Among them, the binder is preferably the polymer of a fluorine compound, and more preferably a polymer of tetrafluoroethylene.

A plurality of binders may be used.

The amount of the binder blended in the electrode is usually about 0.5 to about 30 parts by weight and preferably about 2 to about 30 parts by weight per 100 parts by weight of the carbon material of the present invention.

Examples of the solvent used for the binder include alcohol solvents such as isopropanol, ethanol and methanol; aprotic polar solvents such as N-methyl-2-pyrrolidone; ether solvents; and ketone solvents.

When the binder is viscous, plasticizers may be used in order to easily coat the slurry containing the present carbon material, a binder, a solvent and the like on a current collector.

A lithium ion secondary cell comprising the carbon material of the present invention will be illustrated. The lithium ion secondary cell usually has a cathode, a separator, an electrolyte and an anode, and reduction oxidation reactions are conducted on the both of the cathode and anode thereof, and the cell can discharge and charge an electric energy.

The present lithium ion secondary cell has the carbon material of the present invention as the anode and lithium metal or a metal oxide containing lithium as the cathode.

The cathode usually comprises a current collector, a material capable of absorbing and discharging lithium ions, a conducting agent and a binder, and a mixture of the material capable of absorbing and discharging lithium ions, the conducting agent and the binder is supported on a current collector.

Examples of the material capable of absorbing and discharging lithium ions include a lithium composite oxide containing lithium and at least one transition metal selected from the group consisting of V, Mn, Fe, Co and Ni, and a lithium foil. In the viewpoint of a high discharge potential, laminar lithium composite oxides based on α-NaFeO₂ such as a composite oxide of lithium and cobalt and a composite oxide of lithium, nickel and a transition metal other than nickel or aluminum and lithium composite oxides based on a spinel structure such as lithium manganese spinel are preferable.

Examples of the binder used for the cathode include the same as described above.

Examples of the conducting agent include the carbon material of the present invention, natural graphite, artificial graphite, coke and carbon black. These may be used alone or a mixture of two or more thereof such as a mixture of artificial graphite and carbon black may be used.

Examples of the electrolyte include non-aqueous electrolyte solutions obtained by dissolving a lithium salt in an organic solvent. Examples of the lithium salt include LiClO₄, LiPF₆, LiAsF₆, LiSbF₆, LiBF₄, CF₃SO₃Li, (CF₃SO₂)₂NLi (CF₃SO₂)₃CLi, Li₂B₁₀Cl₁₀, LiAlCl₄, lithium lower aliphatic carboxylates and a mixture thereof. Among them, at least one selected from the group consisting of LiPF₆, LiAsF₆, LiSbF₆, LiBF₄, CF₃SO₃Li, (CF₃SO₂)₂NLi and (CF₃SO₂)₃CLi is preferably used.

Examples of the organic solvent include carbonate solvents such as propylene carbonate, ethylene carbonate, dimethyl carbonate, diethyl carbonate, ethyl methyl carbonate, 4-trifluoromethyl-1,3-dioxolan-2-one and 1,2-di(methoxycarbonyloxy)ethane; ether solvents such as 1,2-dimethoxyethane, 1,3-dimethoxypropane, pentafluoropropyl methyl ether, 2,2,3,3-tetrafluoropropyl difluoromethyl ether, tetrahydrofuran and 2-methyltetrahydrofuran; ester solvents such as methyl formate, methyl acetate, γ-butyrolactone; nitrile solvents such as acetonitrile and butyronitrile; amide solvents such as N,N-dimethylformamide and N,N-dimethylacetamide; carbamate solvents such as 3-methyl-2-oxazolidinone; sulfur-containing solvents such as sulfolane, dimethylsulfoxide and 1,3-propane sultone; and these solvents having at least one fluorinated substituent. These may be used alone or a mixture of two or more kinds of these solvents may be used.

A separator can separate a cathode from an anode and hold an electrolyte. A membrane having large ion permeability, a predefined mechanical strength and electric insulating ability is usually used for the separator.

Examples of the separator include papers made of a viscose rayon, natural cellulose and the like; mixed papers made of fibers such as cellulose and polyester; electrolytic papers; kraft papers; manila papers; non-woven fabrics such as polyethylene non-woven fabrics, polypropylene non-woven fabrics, polyester non-woven fabrics, glass fibers, aramid fibers, polybutyleneterephthalate non-woven fabrics and wholly aromatic p-polyamides; porous membranes such as porous polyethylenes, porous polypropylenes, porous polyesters and fluorine-containing resins such as polyvinylidene fluoride, polytetrafluoroethylene, copolymers of vinylidene fluoride and hexafluoro propylene and fluororubber.

The separator may be a molded article composed of particles of ceramics such as silica and the above-mentioned binders. The molded article is usually integrally molded with both of positive and negative electrodes. A separator made of polyethylene or polypropylene may contain surfactants or silica particles to enhance hydrophilicity thereof. The separator may further contain organic solvents such as acetone, plasticizers such as dibutyl phthalate (DBP), and others.

As the separator, a proton conductive polymer can be used.

Among them, electrolytic papers, papers made of a viscose rayon or natural cellulose, kraft papers, manila papers, mixed papers made of cellulose or polyester fibers, polyethylene non-woven fabrics, polypropylene non-woven fabrics, polyester non-woven fabrics, sheets of Manila hemp and sheets of glass fibers are preferable.

The separator usually has pores of about 0.01 to about 10 μm. The separator usually has thickness of about 1 to about 300 μm, and preferably about 5 to about 30 μm.

The separator may be a layered separator laminating separators having different pore ratios. A separator comprising a polyolefin porous membrane and a polyester resin porous membrane is especially preferable.

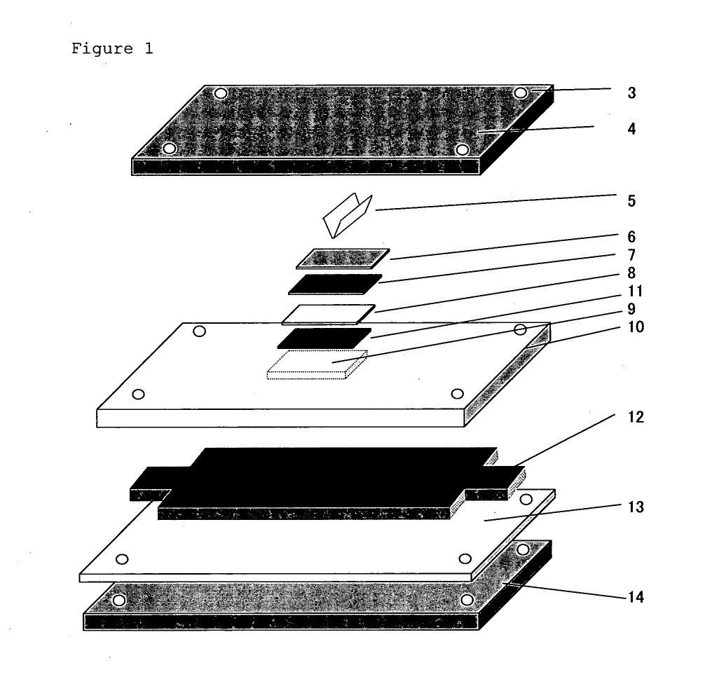

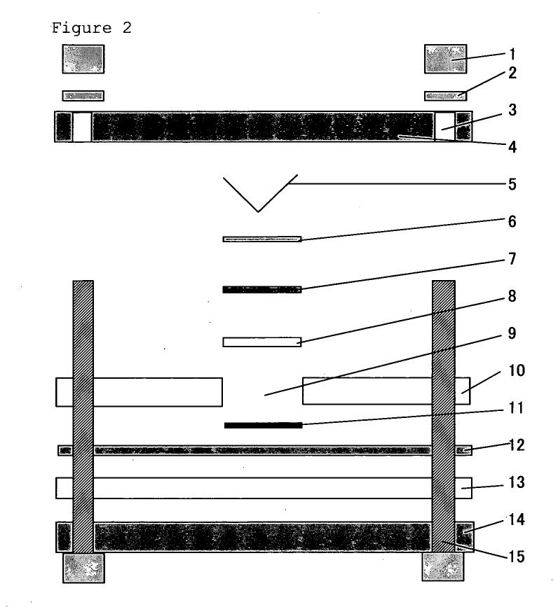

The lithium ion secondary cell of the present invention usually has an initial charge and discharge capacity of 350 mAh/g or more and preferably has that of 390 mAh/g to 460 mAh/g. The initial charge and discharge capacity is measured using the cell shown in FIGS. 1 and 2 with a charge and discharge evaluation apparatus TOSCAT-3100 manufactured by TOYO SYSTEM CO., LTD.

The measurement method is followed: The cell is subjected to charging with constant current of current density of 60 mA/g until the voltage reaches 0 V and then, the cell is subjected to charging with constant potential of 0 V. The total time of charging with constant current of current density of 60 mA/g and charging with constant potential of 0 V is 12 hours. After completion of the charging with constant potential of 0 V, the cell is subjected to discharging with constant current of current density of 60 mA/g until the voltage reaches 1.5 V. In this charging/discharging operation, a quantity of electricity during discharging is cumulated and “initial charge and discharge capacity” means a cumulated quantity of electricity during discharging.

A process for producing the cell shown in FIGS. 1 and 2 is as followed.

Appropriate quantities of N-methyl-2-pyrrolidone are added to a mixture of 91 parts by weight of the carbon material of the present invention and 9 parts by weight of polyvinylidene fluoride, and the resultant mixture is kneaded. The obtained mixture is applied on copper current collector (thickness: 20 μm) using doctor blade method, and the applied current collector is dried at 50° C. for 2 hours. The dried current collector is cut into a 3 cm²-piece (2 cm×1.5 cm) and dried at 120° C. for 8 hours in vacuo to obtain an electrode (11) being an anode. A fixing metallic plate (14) made of stainless steel, an insulating plate (13) made of polytetrafluoroethylene, a metallic plate (12) made of stainless steel and a chassis (10) made of polytetrafluoroethylene are layered in this order. The chassis (10) has a hole (9) (2 cm×1.5 cm). A metallic plate (12) made of stainless steel (thickness: about 100 μm), an electrode (11), a separator (8) made of non-woven fabrics cellulose (TF40-50, manufactured by NIPPON KODOSHI CORPORATION, 2 cm×1.5 cm, thickness: 50 μm) and a cathode (7) (lithium foil, 2 cm×1.5 cm, thickness: about 300 μm) are layered in this order within the hole (9) and an electrolyte (propylene carbonate solution of LiPF₆, concentration: 1 mol/L) is added in the hole (9) to dip the metallic plate (12), the electrode (11), the separator (8) and the cathode (7). A metallic plate (6) made of stainless steel (2 cm×1.5 cm, thickness: about 500 μm) and a blade spring (5) is layered in the hole (9) in this order, and a fixing metallic plate (4) is put thereon. The cell is sealed by fastening bolts (15). To the nut (1), a (−)-current terminal and a (−)-voltage terminal of the charge and discharge evaluation apparatus TOSCAT-3100 are connected and (+)-current terminal and (+)-voltage terminal of the charge and discharge evaluation apparatus TOSCAT-3100 are connected to the metallic plate (12).

The electrode of the present invention can be used for an electrode of a lithium ion capacitor. Examples of the lithium ion capacitor include a lithium ion capacitor wherein a cathode is active carbon and an anode is the electrode of the present invention where lithium ions are doped.

Examples of the electrolyte of the lithium ion capacitor include the same lithium salt solutions in the organic solvent as described above.

The lithium ion capacitor usually contains the above-mentioned separator.

### EXAMPLES

The present invention will be illustrated in more detail by Examples bellow, but the present invention is not limited to these Examples.

A ratio of number of hydrogen atoms to number of carbon atoms (hereinafter, simply referred to as H/C ratio) and a carbon content of the obtained carbon material was calculated based on the results of elemental analysis measured with CHN automated analytical apparatus (vario EL) manufactured by Elementar Analysensysteme GmbH.

A specific surface area of the obtained carbon material was calculated from a nitrogen adsorption isothermal curve at liquid nitrogen temperature using AUTOSORB manufactured by YUASA IONICS INC.

A median particle diameter based on volume (hereinafter, simply referred to as D₅₀) was measured by laser diffraction scattering method with SALD-2200 manufactured by Shimazu Corporation.

An initial charge and discharge capacity was measured using the cell shown in FIG. 1 with a charge and discharge evaluation apparatus TOSCAT-3100 manufactured by TOYO SYSTEM CO., LTD.

The measurement method was followed: The cell was subjected to charging with constant current of current density of 60 mA/g until the voltage reached 0 V and then, the cell was subjected to charging with constant potential of 0 V. The total time of charging with constant current of current density of 60 mA/g and charging with constant potential of 0 V was 12 hours. After completion of the charging with constant potential of 0 V, the cell was subjected to discharging with constant current of current density of 60 mA/g until the voltage reached 1.5 V. The initial charge and discharge capacity was calculated by cumulating quantities of electricity during the discharging.

### Example 1

(1) Into a flask, 30 parts by weight of resorcinol, 120 parts by volume of ethanol and 19.8 parts by weight of n-butyraldehyde were charged under nitrogen flow, and the resultant mixture was cooled in an ice-bath. To the mixture, 54 parts by weight of 36% by weight hydrochloric acid was added dropwise with stirring. The obtained mixture was heated to 60° C., and the mixture was kept at 60° C. for 1 hour. To the mixture, 320 parts by weight of water was added and the precipitate was separated by filtration. The precipitate was washed with water until the filtrate neutralized to obtain 40.2 parts by weight of the compound represented by the formula (a):

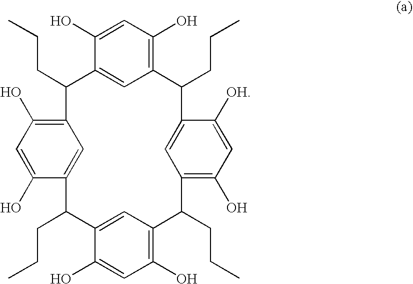

FD-MS: m/z=656.

(2) Into the container, 3.82 parts by weight of the compound represented by the formula (a), which was obtained in the above-mentioned (1), 25 parts by weight of 10% by weight aqueous sodium carbonate solution, 1.89 parts by weight of 37% by weight formalin and 130 parts by weight of water were added at room temperature and the resultant mixture was stirred at room temperature. The obtained mixture was transferred to a stainless-steel container and kept at 80° C. for 20 hours to obtain a polymer. The obtained polymer was coarsely broken and the broken polymer was added to a 50% by weight aqueous acetic acid solution. The resultant mixture was stirred at 60° C. for 1 hour and filtrated to obtain the polymer. The obtained polymer was added to a 50% by weight aqueous acetic acid solution. The resultant mixture was stirred at 60° C. for 1 hour and filtrated to obtain the polymer. The polymer was added to tert-butanol and the resultant mixture was stirred at 60° C. for 1 hour, and filtrated to obtain the polymer. The obtained polymer was dried at 60° C. for 24 hours under reduced pressure to obtain the dried polymer.
(3) The dried polymer obtained in above-mentioned (2) was placed into a rotary kiln manufactured by Advantec Toyo Kaisha, Ltd., and an argon gas was put into the rotary kiln. The polymer was heated from room temperature up to 800° C. at the rate of about 5° C./min. with flowing an argon gas through the rotary kiln at the rate of 0.1 L per 1 part by weight of the polymer, and kept at 800° C. for 1 hour followed by cooling to obtain a carbon material. The obtained carbon material was ground using a ball mill having a ball made of agate at 28 rpm for 5 minutes to obtain a powdery carbon material.

A carbon content of the obtained carbon material was 86% and D₅₀ was 6 μm.

H/C ratio and a specific surface area of the obtained carbon material are shown in Table 1.

(4) Appropriate quantities of N-methyl-2-pyrrolidone were added to a mixture of 91 parts by weight of the carbon material obtained in the above-mentioned (3) and 9 parts by weight of polyvinylidene fluoride, and the resultant mixture was kneaded. The obtained mixture was applied on copper current collector (thickness: 20 μm) using doctor blade method, and the applied current collector is dried at 50° C. for 2 hours. The dried current collector is cut into a 3 cm²-piece (2 cm×1.5 cm) and dried at 120° C. for 8 hours in vacuo to obtain an electrode. The obtained electrode contained 8.2 mg of the mixture of the carbon material obtained and polyvinylidene fluoride.

The cell shown in FIGS. 1 and 2 was prepared using the obtained electrode. The initial charge and discharge capacity is shown in Table 1.

### Example 2

(1) Into a flask, 30 parts by weight of resorcinol, 88 parts by weight of methanol and 7 parts by weight of concentrated sulfuric acid were charged under nitrogen flow, and the resultant mixture was cooled in an ice-bath. To the mixture, 21.1 parts by weight of butyraldehyde was added dropwise with stirring. The obtained mixture was heated to 60° C., and the mixture was kept at 60° C. for 2 hours. The obtained mixture was cooled in an ice-bath, and 13.9 parts by weight of 25% by weight aqueous ammonia solution was added to obtain a solution containing the compound represented by the above-mentioned formula (a).
(2) To the solution containing the compound represented by the above-mentioned formula (a), which was obtained in the above-mentioned (1), 22.1 parts by weight of 37% by weight formalin was added dropwise and the resultant mixture was heated to 70° C. and kept at 70° C. for 12 hours. The reaction mixture obtained was cooled to room temperature and filtrated to obtain 85.1 parts by weight of a polymer. The obtained polymer was added to 340 parts by weight of water and the resultant mixture was kept at 60° C. for 1 hour. The mixture was filtrated to obtain the polymer. The obtained polymer was added to 340 parts by weight of water and the resultant mixture was kept at 60° C. for 1 hour. The mixture was filtrated to obtain the polymer. The obtained polymer was added to 340 parts by weight of water and the resultant mixture was kept at 60° C. for 1 hour. The mixture was filtrated to obtain the polymer. The obtained polymer was dried at 60° C. for 24 hours under reduced pressure to obtain 53.8 parts by weight of the dried polymer.
(3) The dried polymer obtained in the above-mentioned (2) was placed into a rotary kiln manufactured by Advantec Toyo Kaisha, Ltd., and a nitrogen gas was put into the rotary kiln. The polymer was heated from room temperature up to 1,000° C. at the rate of about 5° C./min. with flowing a nitrogen gas through the rotary kiln at the rate of 0.1 L per 1 part by weight of the polymer, and kept at 1,000° C. for 1 hour followed by cooling to obtain a carbon material. The obtained carbon material was ground using a ball mill having a ball made of agate at 28 rpm for 5 minutes to obtain a powdery carbon material.

H/C ratio and a specific surface area of the obtained carbon material are shown in Table 1.

(4) The cell was prepared according to the same as that described in Example 1 (4), except that the carbon material obtained in the above-mentioned (3) was used in place of the carbon material obtained in Example 1 (3).

The initial charge and discharge capacity is shown in Table 1.

### Example 3

The dried polymer obtained in the above-mentioned Example 2 (2) was placed into a rotary kiln manufactured by Advantec Toyo. Kaisha, Ltd., and a nitrogen gas was put into the rotary kiln. The polymer was heated from room temperature up to 900° C. at the rate of about 5° C./min. with flowing a nitrogen gas through the rotary kiln at the rate of 0.1 L per 1 part by weight of the polymer, and kept at 900° C. for 1 hour followed by cooling to obtain a carbon material. The obtained carbon material was ground using a ball mill having a ball made of agate at 28 rpm for 5 minutes to obtain a powdery carbon material.

H/C ratio and a specific surface area of the obtained carbon material are shown in Table 1.

The cell was prepared according to the same as that described in Example 1 (4), except that the carbon material obtained in the above was used in place of the carbon material obtained in Example 1 (3).

The initial charge and discharge capacity is shown in Table 1.

### Example 4

The dried polymer was obtained according to the same as that described in Example 2 (1) and (2).

The dried polymer obtained was placed into a rotary kiln manufactured by Advantec Toyo Kaisha, Ltd. The polymer was heated from room temperature up to 185° C. at the rate of about 3° C./min. with flowing an air through the rotary kiln at the rate of 0.05 L per 1 part by weight of the polymer. After the temperature was reached at 185° C., the calcined product was promptly cooled to room temperature.

A nitrogen gas was put into the rotary kiln, and the calcined product was heated from room temperature up to 1,000° C. at the rate of about 5° C./min. with flowing a nitrogen gas through the rotary kiln at the rate of 0.1 L per 1 part by weight of the calcined product, and kept at 1,000° C. for 1 hour followed by cooling to obtain a carbon material. The obtained carbon material was ground using a ball mill having a ball made of agate at 28 rpm for 5 minutes to obtain a powdery carbon material.

H/C ratio and a specific surface area of the obtained carbon material are shown in Table 1.

The cell was prepared according to the same as that described in Example 1 (4), except that the carbon material obtained in the above was used in place of the carbon material obtained in Example 1 (3).

The initial charge and discharge capacity is shown in Table 1.

### Example 5

The dried polymer was obtained according to the same as that described in Example 2 (1) and (2).

The dried polymer obtained was placed into a rotary kiln manufactured by Advantec Toyo Kaisha, Ltd. The polymer was heated from room temperature up to 185° C. at the rate of about 3° C./min. with flowing an air through the rotary kiln at the rate of 0.05 L per 1 part by weight of the polymer. After the temperature was reached at 185° C., the calcined product was promptly cooled to room temperature.

A nitrogen gas was put into the rotary kiln, and the calcined product was heated from room temperature up to 900° C. at the rate of about 5° C./min. with flowing a nitrogen gas through the rotary kiln at the rate of 0.1 L per 1 part by weight of the calcined product, and kept at 900° C. for 1 hour followed by cooling to obtain a carbon material. The obtained carbon material was ground using a ball mill having a ball made of agate at 28 rpm for 5 minutes to obtain a powdery carbon material.

H/C ratio and a specific surface area of the obtained carbon material are shown in Table 1.

The cell was prepared according to the same as that described in Example 1 (4), except that the carbon material obtained in the above was used in place of the carbon material obtained in Example 1 (3).

The initial charge and discharge capacity is shown in Table 1.

### Example 6

The dried polymer was obtained according to the same as that described in Example 2 (1) and (2).

The dried polymer obtained was placed into a rotary kiln manufactured by Advantec Toyo Kaisha, Ltd. The polymer was heated from room temperature up to 185° C. at the rate of about 3° C./min. with flowing an air through the rotary kiln at the rate of 0.05 L per 1 part by weight of the polymer. After the temperature was reached at 185° C., the calcined product was promptly cooled to room temperature.

A nitrogen gas was put into the rotary kiln, and the calcined product was heated from room temperature up to 800° C. at the rate of about 5° C./min. with flowing a nitrogen gas through the rotary kiln at the rate of 0.1 L per 1 part by weight of the calcined product, and kept at 800° C. for 1 hour followed by cooling to obtain a carbon material. The obtained carbon material was ground using a ball mill having a ball made of agate at 28 rpm for 5 minutes to obtain a powdery carbon material.

H/C ratio and a specific surface area of the obtained carbon material are shown in Table 1.

The cell was prepared according to the same as that described in Example 1 (4), except that the carbon material obtained in the above was used in place of the carbon material obtained in Example 1 (3).

The initial charge and discharge capacity is shown in Table 1.

### Example 7

The powdery carbon material was obtained according to the same as that described in Example 4, except that the calcined product was cooled to room temperature after keeping at 185° C. for 1 hour in place of promptly cooling the calcined product after reaching at 185° C.

H/C ratio and a specific surface area of the obtained carbon material are shown in Table 1.

The cell was prepared according to the same as that described in Example 1 (4), except that the carbon material obtained in the above was used in place of the carbon material obtained in Example 1 (3).

The initial charge and discharge capacity is shown in Table 1.

### Example 8

(1) A solution containing the compound represented by the above-mentioned formula (a) was obtained according to the same as that described in Example 2 (1), except that 0.27 parts by weight of 25% by weight aqueous ammonia solution was used in place of 13.9 parts by weight of 25% by weight aqueous ammonia solution.
(2) The dried polymer was obtained according to the same as that described in Example 2 (2), except that the resultant mixture was heated to 50° C. and kept at 50° C. for 6 hours in place of heating the resultant mixture to 70° C. and keeping at 70° C. for 12 hours.
(3) The powdery carbon material was obtained according to the same as described in Example 3, except that the dried polymer, which was obtained in the above-mentioned (2), was used in place of the dried polymer obtained in the above-mentioned Example 2 (2).

H/C ratio and a specific surface area of the obtained carbon material are shown in Table 1.

(4) The cell was prepared according to the same as that described in Example 1 (4), except that the carbon material obtained in the above-mentioned (3) was used in place of the carbon material obtained in Example 1 (3).

The initial charge and discharge capacity is shown in Table 1.

### Example 9

The powdery carbon material was obtained according to the same as described in Example 3, except that the nitrogen gas flow rate was 0.08 L per 1 part by weight of the polymer in place of the nitrogen gas flow rate of 0.1 L per 1 part by weight of the polymer.

H/C ratio and a specific surface area of the obtained carbon material are shown in Table 1.

The cell was prepared according to the same as that described in Example 1 (4), except that the carbon material obtained in the above was used in place of the carbon material obtained in Example 1 (3).

The initial charge and discharge capacity is shown in Table 1.

### Example 10

The powdery carbon material was obtained according to the same as described in Example 5, except that the nitrogen gas flow rate was 0.05 L per 1 part by weight of the polymer in place of the nitrogen gas flow rate of 0.1 L per 1 part by weight of the polymer.

H/C ratio and a specific surface area of the obtained carbon material are shown in Table 1.

The cell was prepared according to the same as that described in Example 1 (4), except that the carbon material obtained in the above was used in place of the carbon material obtained in Example 1 (3).

The initial charge and discharge capacity is shown in Table 1.

### Example 11

(1) Into a flask, 120 parts by weight of resorcinol, 352 parts by weight of methanol and 28 parts by weight of concentrated sulfuric acid were charged under nitrogen flow, and the resultant mixture was cooled in an ice-bath. To the mixture, 66 parts by weight of propionaldehyde was added dropwise with stirring. The obtained mixture was heated to 60° C., and the mixture was kept at 60° C. for 5 hours. The obtained mixture was cooled in an ice-bath, and 56 parts by weight of 25% by weight aqueous ammonia solution was added thereto to obtain a solution containing the compound represented by the formula (b):

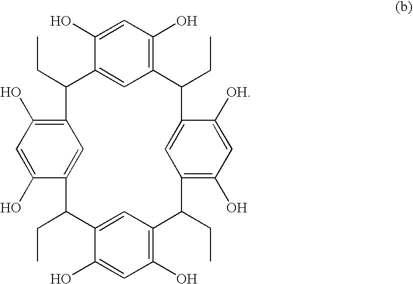

(2) To the solution containing the compound represented by the formula (b), which was obtained in the above-mentioned (1), 88 parts by weight of 37 wt % formalin was added dropwise, and the resultant mixture was heated to 60° C. and kept at 60° C. for 6 hours. The mixture was cooled to room temperature and filtrated to obtain 380 parts by weight of a polymer. To 400 parts by weight of water, 100 parts by weight of the obtained polymer was added, and the resultant mixture was stirred at 60° C. for 1 hour, and filtrated to obtain the polymer. The obtained polymer was added to 400 parts by weight of water, and the resultant mixture was stirred at 60° C. for 1 hour, and filtrated to obtain the polymer. The obtained polymer was added to 400 parts by weight of water, and the resultant mixture was stirred at 60° C. for 1 hour, and filtrated to obtain the polymer. The obtained polymer was dried at 60° C. for 24 hours under reduced pressure to obtain 51 parts by weight of the dried polymer.
(3) The dried polymer obtained in the above-mentioned (2) was placed into a rotary kiln manufactured by Advantec Toyo Kaisha, Ltd., and heated from room temperature up to 185° C. at the rate of about 3° C./min. with flowing an air through the rotary kiln at the rate of 0.05 L per 1 part by weight of the polymer. After the temperature was reached at 185° C., the calcined product was promptly cooled to room temperature.

A nitrogen gas was put into the rotary kiln, and the calcined product was heated from room temperature up to 900° C. at the rate of about 5° C./min. with flowing a nitrogen gas through the rotary kiln at the rate of 0.1 L per 1 part by weight of the calcined product, and kept at 900° C. for 1 hour followed by cooling to obtain a carbon material. The obtained carbon material was ground using a ball mill having a ball made of agate at 28 rpm for 5 minutes to obtain a powdery carbon material.

H/C ratio and a specific surface area of the obtained carbon material are shown in Table 1.

(4) The cell was prepared according to the same as that described in Example 1 (4), except that the carbon material obtained in the above-mentioned (3) was used in place of the carbon material obtained in Example 1 (3).

The initial charge and discharge capacity is shown in Table 1.

### Example 12

(1) A solution containing the compound represented by the above-mentioned formula (b) was obtained according to the same as that described in Example 11 (1).
(2) To the solution containing the compound represented by the formula (b), which was obtained in the above-mentioned (1), 88 parts by weight of 37 wt % formalin was added dropwise, and the resultant mixture was heated to 60° C. and kept at 60° C. for 6 hours. The mixture was cooled to room temperature and filtrated to obtain 380 parts by weight of a polymer. To 400 parts by weight of water, 100 parts by weight of the obtained polymer was added, and the resultant mixture was stirred at 60° C. for 1 hour, and filtrated to obtain the polymer. The obtained polymer was dried at 60° C. for 24 hours under reduced pressure to obtain 51 parts by weight of the dried polymer.
(3) The dried polymer obtained in the above-mentioned (2) was placed into a rotary kiln manufactured by Advantec Toyo Kaisha, Ltd., and heated from room temperature up to 185° C. at the rate of about 3° C./min. with flowing an air through the rotary kiln at the rate of 0.05 L per 1 part by weight of the polymer. After the temperature was reached at 185° C., the calcined product was promptly cooled to room temperature.

A nitrogen gas was put into the rotary kiln, and the calcined product was heated from room temperature up to 900° C. at the rate of about 5° C./min. with flowing a nitrogen gas through the rotary kiln at the rate of 0.1 L per 1 part by weight of the calcined product, and kept at 900° C. for 1 hour followed by cooling to obtain a carbon material. The obtained carbon material was ground using a ball mill having a ball made of agate at 28 rpm for 5 minutes to obtain a powdery carbon material.

H/C ratio and a specific surface area of the obtained carbon material are shown in Table 1.

(4) The cell was prepared according to the same as that described in Example 1 (4), except that the carbon material obtained in the above-mentioned (3) was used in place of the carbon material obtained in Example 1 (3).

The initial charge and discharge capacity is shown in Table 1.

TABLE 1

| | | Specific | Initial Charge and |
|---|---|---|---|
| Example | | Surface Area | Discharge Capacity |
| No. | H/C Ratio | (m²/g) | (mAh/g) |
| 1 | 0.17 | 12 | 386 |
| 2 | 0.11 | 141 | 398 |
| 3 | 0.11 | 472 | 395 |
| 4 | 0.10 | 141 | 384 |
| 5 | 0.13 | 325 | 451 |
| 6 | 0.21 | 469 | 435 |
| 7 | 0.22 | 421 | 413 |
| 8 | 0.13 | 445 | 414 |
| 9 | 0.18 | 399 | 423 |
| 10 | 0.21 | 391 | 430 |
| 11 | 0.12 | 252 | 416 |
| 12 | 0.16 | 493 | 430 |

### Example 13

Appropriate quantities of N-methyl-2-pyrrolidone were added to a mixture of 91 parts by weight of the carbon material obtained in Example 5 and 9 parts by weight of polyvinylidene fluoride, and the resultant mixture was kneaded. The obtained mixture was applied on copper current collector (thickness: 20 μm) using doctor blade method, and the applied current collector is dried at 50° C. for 2 hours. The dried current collector is cut into a 3 cm²-piece (2 cm×1.5 cm) and dried at 120° C. for 8 hours in vacuo to obtain an electrode.

A coin cell (CR2032 Type; IEC/JIS) comprising the obtained electrode as an anode, a lithium foil as a cathode, a separator manufactured by NIPPON KODOSHI CORPORATION (TF40-50) and an electrolyte (propylene carbonate solution of LiPF₆, concentration: 1 mol/L) was prepared.

The prepared coin cell was subjected to charging with 300 mA/g at 45° C. until the voltage reached 0.01 V, and then the charged coin cell was subjected to discharging with 300 mA/g at 45° C. until the voltage became 3V. This charging/discharging operation was taken as 1 cycle and repeated 300 cycles. The steady charge and discharge capacity was measured on 11th cycle. The cumulated quantity of electricity on the 300th cycle was 89% of that on 11th cycle.

This result shows that the cycle property when charging/discharging operation was repeated was excellent.

### Example 14

(1) Into a flask, 30 parts by weight of resorcinol, 120 parts by volume of ethanol and 12.1 parts by weight of acetaldehyde were charged under nitrogen flow, and the resultant mixture was cooled in an ice-bath. To the mixture, 54 parts by weight of 36% by weight hydrochloric acid was added dropwise with stirring. The obtained mixture was heated to 65° C., and the mixture was kept at 65° C. for 5 hours. To the obtained mixture, 320 parts by weight of water was added and the precipitates were collected by filtration. The collected precipitates were washed with water until the filtrate neutralized. After drying the precipitates, the precipitates were crystallized using a mixed solvent of water and ethanol to obtain 13.1 parts by weight of the compound represented by the formula (c):

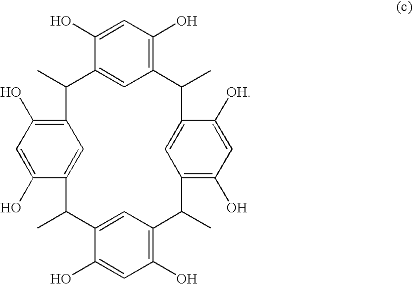

FD-MS: m/z=544

1H-NMR (d₆-dimethyl sulfoxide): δ 1.29 (s, 12H), 4.45 (q, 4H), 6.14 (s, 4H), 6.77 (s, 4H), 8.53 (s, 8H)

(2) To the container, 1.36 parts by weight of the compound represented by the formula (c), which was obtained in the above-mentioned (1), 1.06 parts by weight of sodium carbonate and 0.81 parts by weight of 37% by weight formalin were added, and the resultant mixture was diluted with water. The obtained mixture was heated at 50° C. for 2 days and then at 85° C. for 6 days to obtain a polymer. The obtained polymer was washed three times with 50% by weight aqueous acetic acid solution. The obtained polymer was mixed with tert-butanol and the resultant mixture was kept at 50° C. for 8 hours or more followed by filtrating the mixture to obtain the polymer. This operation was further repeated four times to obtain the polymer. The obtained polymer was freeze-dried at −10° C. for 24 hours under reduced pressure and then freeze-dried at 10° C. for 8 hours under reduced pressure to obtain a dried polymer.
(3) The dried polymer obtained in the above-mentioned (2) was placed into a rotary kiln manufactured by Advantec Toyo Kaisha, Ltd., and an argon gas was put into the rotary kiln, and the polymer was heated at 1,000° C. for 4 hours to obtain a carbon material. The obtained carbon material was ground using a ball mill having a ball made of agate at 28 rpm for 5 minutes to obtain a powdery carbon material.
(4) A cell can be prepared according to the same as that described in Example 1 (4), except that the powdery carbon material obtained in the above-mentioned (3) is used in place of the carbon material obtained in Example 1 (3).

### Example 15

The coin cell prepared in the above-mentioned Example 13 is charged to prepare an electrode where lithium ions are doped. The cell was disassembled to remove the anode. A cell can be prepared by using the removed anode as an anode and an electrode where lithium ions are not doped as a cathode. The call can be used as a lithium ion capacitor.

### Example 16

The dried polymer obtained in the above-mentioned Example 2 (2) was placed into a rotary kiln manufactured by Advantec Toyo Kaisha, Ltd., and a nitrogen gas was put into the rotary kiln. The polymer was heated from room temperature up to 1,000° C. at the rate of about 5° C./min. with flowing an argon gas through the rotary kiln at the rate of 0.1 L per 1 part by weight of the polymer, and kept at 1,000° C. for 1 hour followed by cooling to obtain a carbon material. The obtained carbon material was ground using a jet mill in which nitrogen gas was flowed at a push-in pressure of 1.0 MPa and at a grind pressure of 0.3 MPa to obtain a powdery carbon material.

H/C ratio of the obtained carbon material was 0.13 and a specific surface area of the obtained carbon material was 507 m²/g . D₅₀ was 5 μm.

The cell was prepared according to the same as that described in Example 1 (4), except that the powdery carbon material obtained in the above was used in place of the carbon material obtained in Example 1 (3).

The initial charge and discharge capacity was 405 mAh/g.

### INDUSTRIAL APPLICABILITY

A lithium ion secondary cell having higher initial charge and discharge capacity can be produced by using a carbon material of the present invention, and therefore, it is useful for an electrode for lithium ion cells and the like.

1. A process for producing a carbon material comprising the following steps (A) and (B):
Step (A): a step of reacting a compound represented by the formula (1): 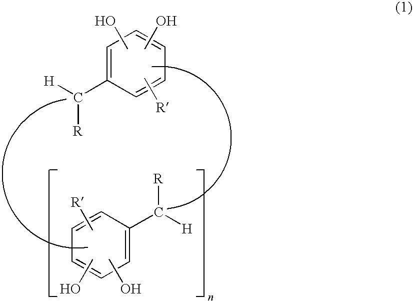
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer,
Step (B): a step of heating the polymer obtained in Step (A) at 600 to 3000° C. under an inert gas atmosphere.

2. A process for producing a carbon material comprising the following steps (A), (C) and (D):
Step (A): a step of reacting a compound represented by the formula (1): 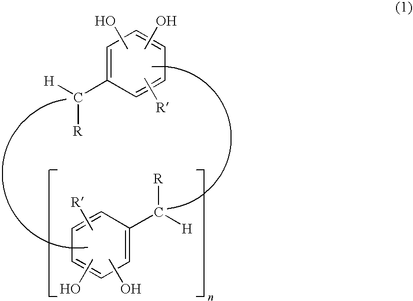
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer,
Step (C): a step of heating the polymer obtained in Step (A) at 400° C. or less under an oxidizing gas atmosphere to obtain a calcined product,
Step (D): a step of heating the calcined product obtained in Step (C) at 600 to 3000° C. under an inert gas atmosphere.

3. The process for producing a carbon material according to claim 1 or 2, wherein the reaction temperature is 0 to 100° C. and the reaction time is 10 minutes to 10 days in Step (A).

4. The process for producing a carbon material according to claim 1, wherein the reaction is conducted in the presence of a basic catalyst in Step (A).

5. The process for producing a carbon material according to claim 1, wherein Step (A) further comprises a step of washing the obtained polymer.

6. The process for producing a carbon material according to claim 1, wherein Step (A) further comprises a step of drying the obtained polymer.

7. The process for producing a carbon material according to claim 1, wherein R′ is a hydrogen atom.

8. The process for producing a carbon material according to claim 1, wherein R is a C1-C12 alkyl group.

9. The process for producing a carbon material according to claim 1, wherein the aldehyde compound is formaldehyde.

10. An electrode comprising a carbon material obtained according to claim 1.

11. A lithium ion secondary cell comprising an electrode according to claim 10.

12. A lithium ion capacitor comprising an electrode according to claim 10.

13. A carbon material obtainable by reacting a compound represented by the formula (1): 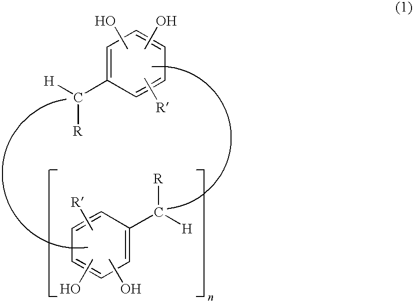
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer, and heating the obtained polymer at 600 to 3000° C. under an inert gas atmosphere.

14. A carbon material obtainable by reacting a compound represented by the formula (1): 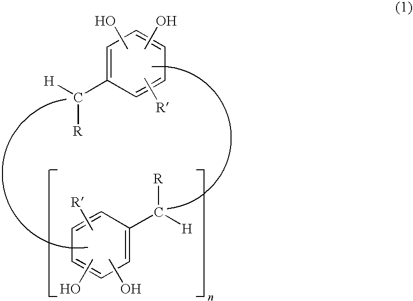
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom, R′ represents a hydrogen atom or a methyl group, and n represents 3, 5 or 7, with an aldehyde compound to obtain a polymer,
heating the obtained polymer at 400° C. or less under an oxidizing gas atmosphere to obtain a calcined product, and
heating the calcined product obtained in the above at 600 to 3000° C. under an inert gas atmosphere.

15. The carbon material according to claim 13 or 14, wherein a ratio of number of hydrogen atoms to number of carbon atoms (H/C) of the carbon material is 0.08 to 0.25.

16. The carbon material according to claim 13, wherein a specific surface area is 0 to 1,000 m²/g.
